(19) United States
(12) Patent Application Publication
(10) Pub. No.: US 2015/0006358 A1
(43) Pub. Date: Jan. 1, 2015

(54) MERCHANT AGGREGATION THROUGH CARDHOLDER BRAND LOYALTY

(71) Applicant: MasterCard International Incorporated, Purchase, NY (US)

(72) Inventors: Steven Bruce Oshry, Bronxville, NY (US); Justin Xavier Howe, Oakdale, NY (US)

(21) Appl. No.: 13/932,560

(22) Filed: Jul. 1, 2013

(51) Int. Cl. G06Q 20/40

(52) U.S. Cl. CPC G06Q 20/40
USPC 705/39

(57) ABSTRACT

A system and method of aggregating merchant data from transaction data, including retrieving a transaction data set from a data warehouse. The transaction data set includes a merchant location identifier and the corresponding merchant's Doing Business As (DBA) name and address data. A data set is then formed from the transaction data, having merchant locations exhibiting at least a threshold level of common cardholder patronage. A metric is calculated related to the textual similarity between a merchant location's DBA name for each pair of merchant locations within the data set. Each pair of merchant locations having a metric related to the textual similarity between the merchant locations' DBA names that exceeds a predetermined threshold are aggregated with each other, where the merchant locations making up the pair do not share an address. The aggregation between merchant locations is recorded in the data warehouse.

### BACKGROUND

1. Field of the Disclosure

The present disclosure relates to electronic transaction processing. More specifically, the present disclosure is directed to method and system for compiling the transactional volume of aggregate merchants to merchant locations.

2. Brief Discussion of Related Art

The use of payment devices for a broad spectrum of cashless transactions has become ubiquitous in the current economy, according to some estimates accounting for hundreds of billions or even trillions of dollars in transaction volume annually. The process and parties typically involved in consummating a cashless payment transaction can be visualized for example as presented in FIG. 1, and can be thought of as a cycle, as indicated by arrow 10. A device holder 12 may present a payment device 14, for example a payment card, transponder device, NFC-enabled smart phone, among others and without limitation, to a merchant 16 as payment for goods and/or services. For simplicity the payment device 14 is depicted as a credit card, although those skilled in the art will appreciate the present disclosure is equally applicable to any cashless payment device, for example and without limitation, contactless RFID-enabled devices including smart cards, NFC-enabled smartphones, electronic mobile wallets or the like. The payment device 14 here is emblematic of any transaction device, real or virtual, by which the device holder 12 as payor and/or the source of funds for the payment may be identified.

In cases where the merchant 16 has an established merchant account with an acquiring bank (also called the acquirer) 20, the merchant communicates with the acquirer to secure payment on the transaction. An acquirer 20 is a party or entity, typically a bank, which is authorized by the network operator 22 to acquire network transactions on behalf of customers of the acquirer 20 (e.g., merchant 16). Occasionally, the merchant 16 does not have an established merchant account with an acquirer 20, but may secure payment on a transaction through a third-party payment provider 18. The third party payment provider 18 does have a merchant account with an acquirer 20, and is further authorized by the acquirer 20 and the network operator 22 to acquire payments on network transactions on behalf of sub-merchants. In this way, the merchant 16 can be authorized and able to accept the payment device 14 from a device holder 12, despite not having a merchant account with an acquirer 20.

The acquirer 20 routes the transaction request to the network operator 22. The data included in the transaction request will identify the source of funds for the transaction. With this information, the network operator 22 routes the transaction to the issuer 24. An issuer 24 is a party or entity, typically a bank, which is authorized by the network operator 22 to issue payment devices 14 on behalf of its customers (e.g., device holder 12) for use in transactions to be completed on the network. The issuer 24 also provides the funding of the transaction to the network provider 22 for transactions that it approves in the process described. The issuer 24 may approve or authorize the transaction request based on criteria such as a device holder's credit limit, account balance, or in certain instances more detailed and particularized criteria including transaction amount, merchant classification, etc., which may optionally be determined in advance in consultation with the device holder and/or a party having financial ownership or responsibility for the account(s) funding the payment device 14, if not solely the device holder 12.

The decision made by the issuer 24 to authorize or decline the transaction is routed through the network operator 22 and acquirer 20, ultimately to the merchant 16 at the point of sale. This entire process is typically carried out by electronic communication, and under routine circumstances (i.e., valid device, adequate funds, etc.) can be completed in a matter of seconds. It permits the merchant 16 to engage in transactions with a device holder 12, and the device holder 12 to partake of the benefits of cashless payment, while the merchant 16 can be assured that payment is secured. This is enabled without the need for a preexisting one-to-one relationship between the merchant 16 and every device holder 12 with whom they may engage in a transaction.

The issuer 24 may then look to its customer, e.g., device holder 12 or other party having financial ownership or responsibility for the account(s) funding the payment device 14, for payment on approved transactions, for example and without limitation, through an existing line of credit where the payment device 14 is a credit card, or from funds on deposit where the payment device 14 is a debit card. Generally, a statement document 26 provides information on the account of a device holder 12, including merchant data as provided by the acquirer 20 via the network operator 22.

The network operator 22 can further build and maintain a data warehouse that stores and augments transaction data, for use in marketing, macroeconomic reporting, etc. To this end, transaction data from multiple transactions is aggregated for reporting purposes according to a location of the merchant 16. Additionally, one merchant 16 may operate plural card acceptance locations. Consider, for example, a chain or franchise having multiple business locations. These merchant locations are beneficially aggregated and assigned an aggregate merchant location identifier for reporting purposes.

Of all the data handled in the transaction process, the merchant's data tends to be the least stable and most difficult with which to deal. One of the challenges with merchant data is the fact that there is no universal merchant location identifier. Rather, the network operator 22 must build and maintain the data warehouse itself, derived from merchant data included in the transaction data delivered via the acquirer 20. Similarly, there is no reliable location identifier in the data received that indicates if a merchant location belongs to a chain or not, for example for aggregation purposes. Again, the network operator 22 augments transactions with this information, based on the received merchant name, the acquiring bank, and several other fields. The process of grouping merchant locations into sets of chain merchants is called “merchant aggregation” and maintaining the integrity of these aggregations is a challenge. Ultimately, the network operator 22 must rely on imperfect inference from the transaction data to perform its merchant aggregation.

Merchants 16 and acquirers 20 do not consistently submit their data in the same way, thus creating the need to monitor the integrity of this data. Merchants 16 can change acquirers 20; they open and close locations; they rebrand themselves—just to name a few of the challenges. When any of these or other changes to merchant data occur, the rules used to assign an identifier to a merchant location and/or associate that merchant location with an aggregate merchant location identifier often fail. Even cursory human oversight of each and every merchant location would be prohibitively expensive considering the total number of merchants 16 accepting authorized payment devices 14, or even that subset of aggregate merchants whom the network operator 22 wishes to monitor.

Merchant identification data, in particular DBA name and address, are notoriously inaccurate and unstable. The data is inaccurate in the sense that it is often provided in a non-standardized in form, and certain data may be cross-polluted among the various fields making up the merchant location entry. There is also the possibility that the data is intentionally fraudulent or misleading by bad actors.

Existing merchant aggregation efforts rely on text matching, address recognition, or even feedback from the merchant to properly group and/or classify merchants in the aggregate. However, no method to date can assure that every eligible merchant location is contained within the aggregate. Furthermore, a merchant point-of-sale (POS) terminal can be resold or transferred among merchants. If the POS terminal is not rebuilt properly before redistributing to a different merchant, techniques that look to the POS terminal identification data to aid in the aggregation may result in inaccuracies. Likewise, an unreputable merchant who intentionally selected their name so as to be mistaken for a different entity would be prone to misaggregation. A solution to this aggregate merchant data quality deficit problem remains wanting.

### SUMMARY

The instant application describes a solution to the problem of aggregate merchant data quality deficit.

Among the problems influencing the merchant data quality deficit is that, in the example of the largest merchants, they may use more than one acquirer 20 to process all of their transaction volume across their entire chain of stores. This may or may not be divided by merchant subsidiary, and may be without regard to plural transaction device 14 acceptance terminals at a given location. Each acquirer 20 may have a different data format for merchant name and location. In some cases, multiple terminals, even those processed through the same acquirer 20 and in the same location of a given merchant 16, may have variations in data presentation. Franchise chain data can be particularly troublesome, as the merchant is generally an independent entity, although the value in data reporting is to be found in aggregating transactions under the franchise umbrella.

A related application by the present inventive entity is entitled MERCHANT CONTINUITY CORRECTION USING CARDHOLDER LOYALTY INFORMATION, filed 2 May 2013 and assigned U.S. patent application Ser. No. 13/875,803 (Applicant Ref. No P00915-US-UTIL; Attorney Docket No. 1788-100), the complete disclosure of which is hereby incorporated by this reference for all purposes. Therein, the present inventors addressed the problem of merchant continuity correction. Changes in merchant data that are not reflective of changes in ownership, e.g., where a merchant had a change in acquirer 20, or installed a new Point-Of-Sale (POS) terminal that introduces a perturbation in merchant identification data such as address or name, induce the network operator 22 to create a new merchant location entry corresponding to the new data. However, such changes are not always indicative of new ownership, and in fact the previous merchant remains open without interruption.

The above-referenced application leverages the characteristic of cardholder loyalty to a particular location. More colloquially, a certain percentage of shoppers/client/customers of a particular merchant tend to remain loyal to that merchant. On the other hand, it would be unusual to see a cohort of cardholders switch loyalty from one merchant to another virtually simultaneously en masse. Therefore, where a disrupted merchant location and a new merchant location exhibit a threshold level of cardholder loyalty, it can be inferred that what are two merchant locations from the perspective of the network operator 22 are in fact one and the same continuous operation. The foregoing analysis and solution also lends itself to an automated implementation.

As applied to merchant aggregation, it has been observed that a certain cohort of cardholders exhibit a degree of loyalty to a particular merchant brand across multiple locations. This brand loyalty can be leveraged as an indicator of relationship between separate merchant locations.

Therefore, provided according to the present disclosure is a method of aggregating merchant data from transaction data. The method includes retrieving transaction data set from a data warehouse, the transaction data set including a merchant location identifier and the corresponding merchant's Doing Business As (DBA) name and address data. A data set is then formed from the transaction data, having merchant locations exhibiting at least a threshold level of common cardholder patronage. A metric is calculated related to the textual similarity between a merchant location's DBA name for each pair of merchant locations within the data set. Each pair of merchant locations having a metric related to the textual similarity between the merchant locations' DBA names that exceeds a predetermined threshold is aggregated with each other, where the merchant locations making up the pair do not share an address. The aggregation between merchant locations is recorded in the data warehouse.

In a further embodiment of the presently disclosed method, each merchant DBA name is pre-processed to remove common, generic or descriptive terms, including without limitation those related to the goods or services sold by the merchant, or to the geographic location of the merchant.

In a further embodiment of the presently disclosed method, the transaction data set comprises transactions occurring within at least one of a predetermined time period, a predetermined geographical location, and involving predetermined merchant characteristics.

Optionally, the merchant pair data in the transaction data set may be graphically represented as an interconnected network, with the merchant locations corresponding to nodes of the network, and where the nodes are connected by edges that correspond to at least one cardholder patronizing both merchant location nodes on either side of the edge. Optionally or additionally, merchant locations that are constituents of a fully connected subgraph are further identified for aggregation.

In a further embodiment of the presently disclosed method, the threshold level of common cardholder patronage is related to at least one of a number of cardholders patronizing both merchant locations of a pair, a number of transactions with both merchants each cardholder makes, a percentage of common cardholders as a portion of the client base for each connected merchant location independently, the product of the percentage of cardholders overlapping from each location independently, or some combination of these.

In a further embodiment of the presently disclosed method, the metric related to the textual similarity between the merchant locations' DBA names comprises at least one of inverse document frequency measurement, Levenshtein Distance, a Soundex comparison, and an value related to each common substring of any length between the respective merchant locations' DBA names.

Further provided according to the present disclosure is a system for aggregating merchant data from transaction data. The disclosed system includes a processor and a non-transitory machine-readable storage medium storing thereon a program of instruction that, when executed by the processor, causes the processor to carry out a method including any of the above-recited features. Further provided according to the present disclosure is a non-transitory machine-readable storage medium described with reference to the system.

These and other purposes, goals and advantages of the present disclosure will become apparent from the following detailed description of example embodiments read in connection with the accompanying drawings.

### BRIEF DESCRIPTION OF THE DRAWINGS

Some embodiments are illustrated by way of example and not limitation in the figures of the accompanying drawings, in which like reference numerals refer to like structures across the several views, and wherein:

FIG. 1 illustrates schematically the process and parties typically involved in consummating a cashless transaction;

FIG. 2 illustrates a flowchart for customer loyalty-based aggregate merchant matching according to an embodiment of the present disclosure;

FIG. 3 depicts a graph structure of interrelated merchant location pairs and respective connecting edges;

FIG. 4 depicts a sample fully connected subgraph of merchant location pairs and edges; and

FIG. 5 illustrates schematically a representative computer according to the present disclosure, operative to implement the disclosed methods.

### DETAILED DESCRIPTION

In the present inventors' work on merchant continuity correction, brand loyalty was, in fact, a problem. That is to say, where a cardholder was loyal to a brand perhaps patronizing many locations of the same brand, the purchase record would include merchants of similar name text. If such a brand-loyal customer responded to the closing of one location by patronizing another location of the same brand, this might be erroneously perceived as an indication of continuity between what were two separate merchant locations, when in fact the separation of locations was appropriate, and one of these locations simply discontinued operation. The presently disclosed method seeks to leverage the customer's brand loyalty among merchant locations having similar DBA names.

Consider, for example, Table 1 below. Table 1 shows a list of merchant locations with many overlapping cardholders. More particularly, each row in Table 1 represents a pair of merchant locations having at least one (or some other threshold number) cardholder who patronized both merchant locations within the data set. Each merchant location is assigned an arbitrary ID. The data in Table 1 was anonymized for the purpose of the present disclosure, however it is representative of actual merchant location data.

The data in Table 1 demonstrates that a cardholder who eats regularly at one BURGER NOW (a fictive, archetype chain of fast food restaurants) location is very likely to patronize other BURGER NOW locations. Therefore, this cardholder brand preference for BURGER NOW could be used as an indicator for merchant aggregation. More specifically, merchant aggregation may be indicated by aggregating two locations with overlapping cardholder patrons, provided their addresses were different, the DBA names were typographically similar, and they had an abnormal number of cardholders shopping at both locations. The BURGER NOW ID H merchant location is particularly demonstrative. The merchant location that served as the basis for BURGER NOW ID H is in fact located in a regional shopping center. That regional shopping center attracts cardholders who normally or regularly visit at least one of 17 surrounding BURGER NOW locations. In this fashion, the noted 18 BURGER NOW locations can be aggregated automatically by relying on the cardholder brand preference.

TABLE 1

| MERCHANT1 | | | | | | MERCHANT2 | | | | | |
|---|---|---|---|---|---|---|---|---|---|---|---|
| | MER- | | | | | | MER- | | | | |
| | CHANT1 | MER- | MER- | | | | CHANT2 | MER- | MER- | | |
| | DBA | CHANT1 | CHANT1 | MER1 | MER1 | | DBA | CHANT2 | CHANT2 | MER2 | MER2 |
| ID 1 | NAME | ADDR | CITY | STATE | ZIP | ID 2 | NAME | ADDR | CITY | STATE | ZIP |
| C | BURGER | 5 APPLE ST | WASHINGTON | DC | 20009 | K | BURGER | 200 ROUTE 1 | WASHINGTON | DC | 20012 |
| | NOW 3 | | | | | | NOW 11 | | | | |
| C | BURGER | 5 APPLE ST | WASHINGTON | DC | 35976 | J | BURGER | 51 US HWY | WASHINGTON | DC | 20011 |
| | NOW 3 | | | | | | NOW 10 | | | | |
| C | BURGER | 5 APPLE ST | WASHINGTON | DC | 35976 | L | BURGER | 1122 FOXWOOD | WASHINGTON | DC | 20056 |
| | NOW 3 | | | | | | NOW 12 | ST | | | |
| B | BURGER | 20 MAIN ST | WASHINGTON | DC | 35957 | J | BURGER | 51 US HWY | WASHINGTON | DC | 20011 |
| | NOW 2 | | | | | | NOW 10 | | | | |
| B | BURGER | 20 MAIN ST | WASHINGTON | DC | 35957 | K | BURGER | 200 ROUTE 1 | WASHINGTON | DC | 20012 |
| | NOW 2 | | | | | | NOW 11 | | | | |
| G | BURGER | 5700 S HWY | WASHINGTON | DC | 35124 | I | BURGER | 123 DEGAUL | WASHINGTON | DC | 20010 |
| | NOW 7 | | | | | | NOW 9 | BLVD | | | |
| A | BURGER | 1000 | WASHINGTON | DC | 35950 | J | BURGER | 51 US HWY | WASHINGTON | DC | 20011 |
| | NOW 1 | PURCHASE | | | | | NOW 10 | | | | |
| | | ST | | | | | | | | | |
| A | BURGER | 1000 | WASHINGTON | DC | 35950 | K | BURGER | 200 ROUTE 1 | WASHINGTON | DC | 20012 |
| | NOW 1 | PURCHASE | | | | | NOW 11 | | | | |
| | | ST | | | | | | | | | |
| A | BURGER | 1000 | WASHINGTON | DC | 35950 | L | BURGER | 1122 FOXWOOD | WASHINGTON | DC | 20056 |
| | NOW 1 | PURCHASE | | | | | NOW 12 | ST | | | |
| | | ST | | | | | | | | | |
| D | BURGER | 3952 | WASHINGTON | DC | 36067 | M | BURGER | 8877 RHODES | WASHINGTON | DC | 20057 |
| | NOW 4 | HARVARD | | | | | NOW 13 | AVE | | | |
| | | DR | | | | | | | | | |
| D | BURGER | 3952 | WASHINGTON | DC | 36067 | N | BURGER | 9966 FIRST ST | WASHINGTON | DC | 20057 |
| | NOW 4 | HARVARD | | | | | NOW 14 | | | | |
| | | DR | | | | | | | | | |
| E | BURGER | 2700 | WASHINGTON | DC | 36037 | N | BURGER | 9966 FIRST ST | WASHINGTON | DC | 20057 |
| | NOW 5 | LAFAYETTE | | | | | NOW 14 | | | | |
| | | PKWY | | | | | | | | | |
| F | BURGER | 8927 | WASHINGTON | DC | 36066 | M | BURGER | 8877 RHODES | WASHINGTON | DC | 20057 |
| | NOW 6 | CENTRAL | | | | | NOW 13 | AVE | | | |
| | | AVE | | | | | | | | | |
| H | BURGER | 696 | QUEENS | NY | 87114 | AA | BURGER | 1012 SANTA | QUEENS | NY | 11080 |
| | NOW 8 | CALIFORNIA | | | | | NOW 27 | ANA HWY | | | |
| | | PL | | | | | | | | | |
| H | BURGER | 696 | QUEENS | NY | 87114 | AB | BURGER | 321 COORS PL | QUEENS | NY | 11081 |
| | NOW 8 | CALIFORNIA | | | | | NOW 28 | | | | |
| | | PL | | | | | | | | | |
| H | BURGER | 696 | QUEENS | NY | 87114 | AC | BURGER | 6853 DELORIEN | QUEENS | NY | 11082 |
| | NOW 8 | CALIFORNIA | | | | | NOW 29 | AVE | | | |
| | | PL | | | | | | | | | |
| H | BURGER | 696 | QUEENS | NY | 87114 | AD | BURGER | 9633 MONTANA | QUEENS | NY | 11083 |
| | NOW 8 | CALIFORNIA | | | | | NOW 30 | DR | | | |
| | | PL | | | | | | | | | |
| H | BURGER | 696 | QUEENS | NY | 87114 | AE | BURGER | 1100 | QUEENS | NY | 11084 |
| | NOW 8 | CALIFORNIA | | | | | NOW 31 | BROADWAY | | | |
| | | PL | | | | | | CT | | | |
| H | BURGER | 696 | QUEENS | NY | 87114 | O | BURGER | 7733 SECOND | QUEENS | NY | 11080 |
| | NOW 8 | CALIFORNIA | | | | | NOW 15 | AVE | | | |
| | | PL | | | | | | | | | |
| H | BURGER | 696 | QUEENS | NY | 87114 | P | BURGER | 5511 BLUE SKY | QUEENS | NY | 10001 |
| | NOW 8 | CALIFORNIA | | | | | NOW 16 | CT | | | |
| | | PL | | | | | | | | | |
| H | BURGER | 696 | QUEENS | NY | 87114 | Q | BURGER | 8342 | QUEENS | NY | 10057 |
| | NOW 8 | CALIFORNIA | | | | | NOW 17 | VETERANS | | | |
| | | PL | | | | | | HWY | | | |
| H | BURGER | 696 | QUEENS | NY | 87114 | R | BURGER | 1664 | QUEENS | NY | 10101 |
| | NOW 8 | CALIFORNIA | | | | | NOW 18 | REVOLU- | | | |
| | | PL | | | | | | TIONARY | | | |
| | | | | | | | | RD | | | |
| H | BURGER | 696 | QUEENS | NY | 87114 | S | BURGER | 100 CANADA | QUEENS | NY | 11750 |
| | NOW 8 | CALIFORNIA | | | | | NOW 19 | WAY | | | |
| | | PL | | | | | | | | | |
| H | BURGER | 696 | QUEENS | NY | 87114 | T | BURGER | 91 MIAMI HWY | QUEENS | NY | 11080 |
| | NOW 8 | CALIFORNIA | | | | | NOW 20 | | | | |
| | | PL | | | | | | | | | |
| H | BURGER | 696 | QUEENS | NY | 87114 | U | BURGER | 1111 SEATTLE | QUEENS | NY | 11081 |
| | NOW 8 | CALIFORNIA | | | | | NOW 21 | AVE | | | |
| | | PL | | | | | | | | | |
| H | BURGER | 696 | QUEENS | NY | 87114 | V | BURGER | 8765 FOURTH | QUEENS | NY | 11082 |
| | NOW 8 | CALIFORNIA | | | | | NOW 22 | ST | | | |
| | | PL | | | | | | | | | |
| H | BURGER | 696 | QUEENS | NY | 87114 | W | BURGER | 2345 BRISAS PL | QUEENS | NY | 11001 |
| | NOW 8 | CALIFORNIA | | | | | NOW 23 | | | | |
| | | PL | | | | | | | | | |
| H | BURGER | 696 | QUEENS | NY | 87114 | X | BURGER | 7896 NORTH | QUEENS | NY | 11005 |
| | NOW 8 | CALIFORNIA | | | | | NOW 24 | PKWY | | | |
| | | PL | | | | | | | | | |
| H | BURGER | 696 | QUEENS | NY | 87114 | Y | BURGER | 4567 BUDSK | QUEENS | NY | 10057 |
| | NOW 8 | CALIFORNIA | | | | | NOW 25 | HWY | | | |
| | | PL | | | | | | | | | |
| H | BURGER | 696 | QUEENS | NY | 87114 | Z | BURGER | 6204 ALABAMA | WASHINGTON | DC | 20008 |
| | NOW 8 | CALIFORNIA | | | | | NOW 26 | BLVD | | | |
| | | PL | | | | | | | | | |

The disclosed method also allows merchant aggregation with reduced emphasis on text matching. The method is therefore well suited to automated aggregate merchant matching in foreign countries that rely on transliteration for payment network merchant data.

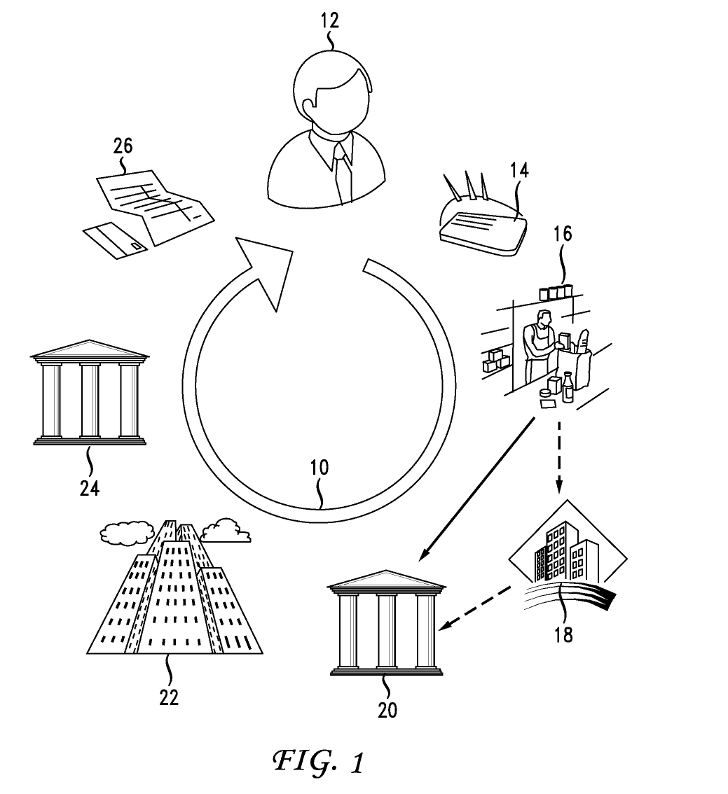

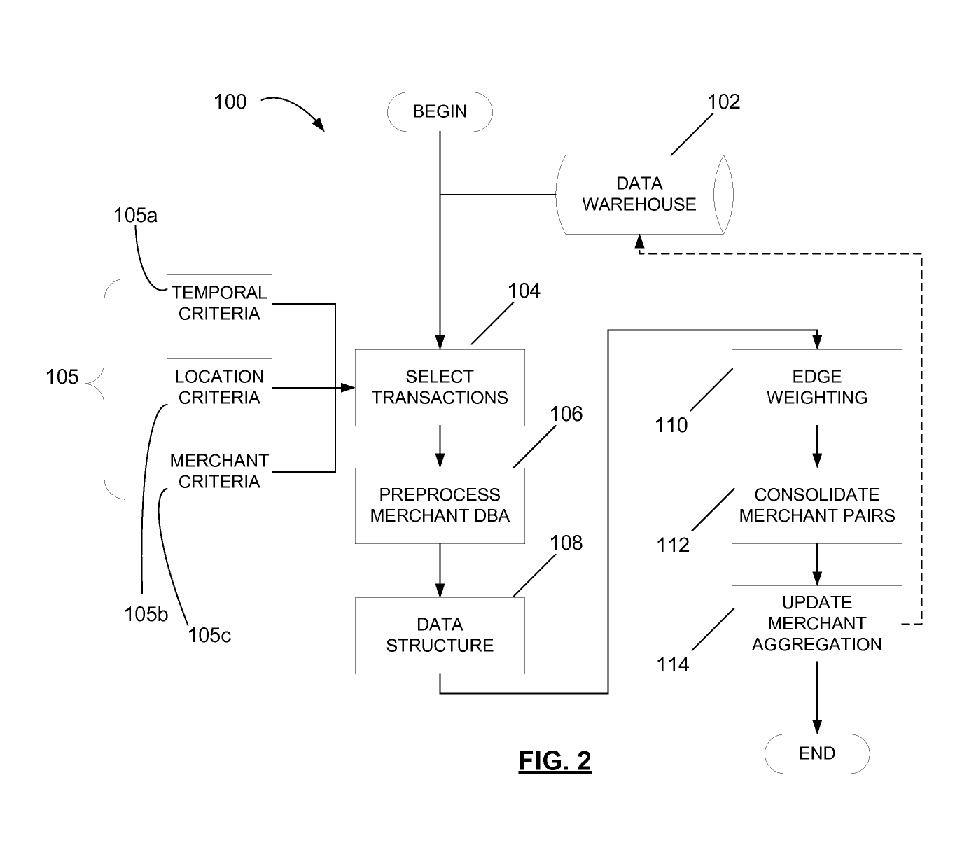

Referring now to FIG. 2, illustrated is a process, generally 100, for consumer brand loyalty-based merchant aggregation according to an embodiment of the present disclosure. The network operator 22 (see FIG. 1) maintains one or more databases 102, colloquially called a ‘data warehouse’, including transaction records for all of its processed transactions, numbering in the millions daily. A selection is made 104 of a manageable and representative subset of those transactions from the data warehouse 102.

Certain threshold criteria 105 can be applied in order to cull this data set at the selection phase 104. Threshold criteria 105 may include a temporal criteria 105a. Under the temporal criteria 105a, the data under consideration may be time-limited, looking only to transactions within a predetermined period of time, e.g., day, week, month, or any other arbitrary timeframe. It will be appreciated that longer timeframes will allow more merchant pairs to emerge among cardholders. On the other hand, larger sample sizes are more computationally intensive. Alternately or additionally, the merchant data set can be culled by applying a location criteria 105b. Location criteria 105b would limit the geographic location of the merchant (e.g., city, state, region, country, etc.). Moreover, the time criteria 105a and location criteria 105b may be interrelated and combined, upon consideration of a typical cardholder's ability to patronize two merchants within the prescribed geographic area and the determined time span.

Alternately or additionally, merchant characteristic criteria 105c may be applied. Merchant aggregation in general is typically, though not exclusively, applied to brick-and-mortar business locations. Therefore, and when brick-and-mortar locations are the focus of inquiry, merchant locations of a given class, for example those that are, as example only and without limitation, known to be partially, exclusively, or predominantly e-commerce merchants, mail-order merchants, telephone-order merchants, or centrally-billed merchants (i.e., those where the address of the merchant location billing the customer and/or customer's payment device 14 is remote from the location of the customer or where the product or service is delivered to the customer), can be removed from consideration. The reverse will also be seen as applicable, for example by eliminating brick-and-mortar merchant locations to aggregate related e-commerce, etc., merchants. Moreover, the method may be performed without regard to merchant class where the intention is to aggregate an online retailer with a corresponding brick-and-mortar presence.

Optionally, certain data pre-processing 106 can be performed to improve the power of a textual match between respective merchant location DBA names. For example, a black list of common, generic, or descriptive terms may be excised from the merchant DBA name before performing a comparison. The blacklist terms at issue include those that relate to the goods or services provided, including without limitation, “pizza,” “restaurant,” “salon,” etc. Geographic indicators, e.g., a city name or street name included in a given merchant location entry, can likewise be removed from the merchant location DBA name field for the purpose of subsequent textual similarity comparison. Such generic terms will have little distinguishing or predictive power to indicate related merchants that are amenable to aggregation.

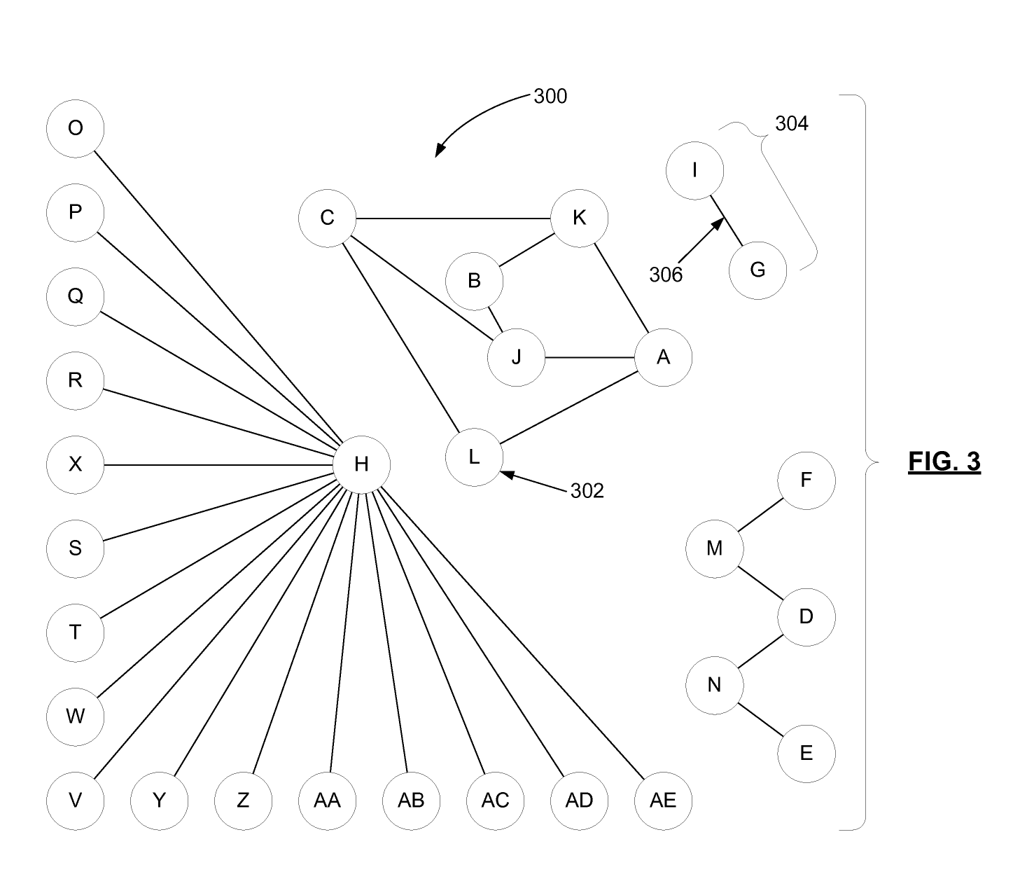

The selected data is structured 108 for aggregate matching. The simplest implementation of the pre-processed data is a list of all merchant pairs, e.g., Table 1. A merchant pair in Table 1 represents that one cardholder patronized both merchant locations represented in each line of the table. Alternately, an undirected graph structure can be prepared, with reference to FIG. 3, generally 300. Each merchant in the transaction data set is represented as a node 302 on the graph 300. More specifically, merchant location nodes 302 are individually labeled by their assigned ID represented in Table 1. Each merchant pair 304 having at least one cardholder in common, i.e., merchants for whom there exists at least one cardholder who patronized both merchants in the transaction data set, is connected by an edge 306 of the graph 300.

Referring again to FIG. 2, the merchant locations remaining in the data set from 108 are subjected to an edge weighting 110. The edge weight for each merchant pair can be incremented for each unique cardholder in the transaction data set who patronized both merchants. There can be further weight given to a particular edge between two merchants in a given pair according to higher number of transactions with both merchants each cardholder makes. A threshold edge weight could be the number of cardholder accounts in common, a percentage of cardholders that the overlap represents for either location independently, the product of the percentage of cardholders overlapping from each location independently, or another metric including a combination of one or more of these. Merchant locations not meeting the threshold criteria are ultimately discarded from the data set.

Merchant location pairs meeting an edge weight criteria 110 can then be further pruned, or consolidated 112, based upon a substring matching metric on the respective DBA names. DBA name matching may further include the optional pre-processing 106 described above. Textual similarity can be determined by a variety of methods. Known methods of measuring textual similarity include term frequency—inverse document frequency (tf-idf) measurement; Levenshtein Distance; or Soundex comparison, among others. At least one method of determining textual similarity is disclosed in U.S. Pat. No. 8,219,550, issued 10 Jul. 2012 to Merz, et al., (“Merz '550”), which is a continuation application of U.S. Pat. No. 7,925,652 issued 12 Apr. 2011 (“Merz '652”), both patents being commonly assigned with the instant application. The disclosures of both Merz '550 and Merz '652 are hereby incorporated by this reference in their entirety for all purposes.

At least one method of substring match metric between the processed DBA name fields, for example, is conducted according to the following method. Comparing respective DBA names for two merchant locations, each character in common increments the metric by 1; each consecutive pair of letters in common the metric is incremented by an additional 1; each substring of three letters in common the metric is incremented by an additional 1; each substring of four letters in common the metric is incremented by an additional 1, and so on until every length of match has been recursively sought in the compared strings until the length of the shorter string has been reached.

Whichever metric employed, the results of the round-robin comparison represented in the edge weighting 110 are consolidated at 112 by comparing the calculated metric against a user-defined threshold. Those edges having a metric that exceed the threshold are aggregated at 114, with appropriate updates made to the data warehouse 102. Any edges that do not have sufficiently similar DBA names to exceed the metric threshold are discarded. Generally, though not exclusively, address similarity is not considered in this edge weighting 110 metric. However, merchant locations are screened against aggregation when the two merchant locations have a sufficient textual similarity in their addresses. This is generally the reverse of the prior-mentioned work concerning merchant continuity correction, where address similarity is a positive indicator of association.

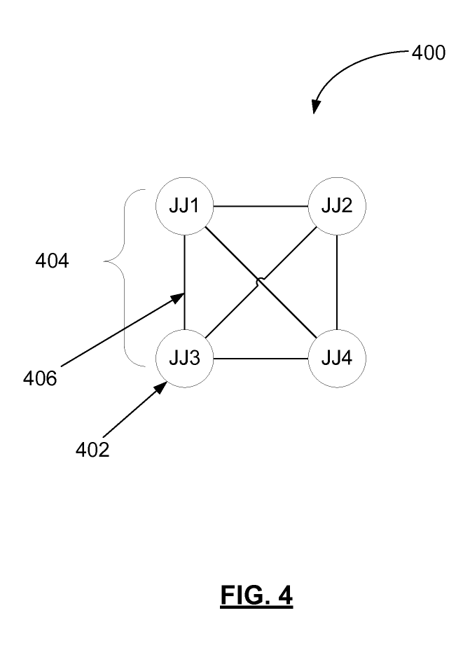

A breadth-first search can then be conducted to add all connected merchant location nodes 302 with edge weights exceeding the user defined threshold to that merchant aggregate. Alternatively or additionally, from the compiled list of all connected merchant locations, sets of fully connected subgraphs may be formed. An example of a fully-connected subgraph is shown below in Table 2, and depicted graphically, generally 400, in FIG. 4.

A fully connected subgraph 400 is a subset of merchant locations where each member of the subset is connected to each other member of the subset with an edge weight that exceeds the threshold criteria. Consider for example Table 2, which represents a group of commonly-branded coffee shops located on a large university campus. The location are each represented as a node 402 in FIG. 4, with each node also being uniquely identifiable (e.g., Java Joe 1=“JJ1”, etc.). Java Joe nodes 402 in FIG. 4 form respective node pairs 404, that are in turn connected with each other by edges 406.

TABLE 2

| Paired Merchant | | Paired Merchant | |
|---|---|---|---|
| Location1 DBA | Address1 | Location 2 DBA | Address2 |
| Java Joe 1 | Springfield U. | Java Joe 2 | Springfield U. |
| | Commons | | Union |
| Java Joe 1 | Springfield U. | Java Joe 3 | Springfield U. |
| | Commons | | Dorms |
| Java Joe 1 | Springfield U. | Java Joe 4 | Springfield U. |
| | Commons | | Administration |
| Java Joe 2 | Springfield U. | Java Joe 3 | Springfield U. |
| | Union | | Dorms |
| Java Joe 2 | Springfield U. | Java Joe 4 | Springfield U. |
| | Union | | Administration |
| Java Joe 3 | Springfield U. | Java Joe 4 | Springfield U. |
| | Dorms | | Administration |

All of these Java Joe locations are frequented by the same cardholders, an indication of brand loyalty, and present an edge weighting that exceeds the threshold for aggregation. Further, the DBA names are similar textually. They will therefore be included in a breadth-first search. Further, the example subgroup 400 is fully-connected. This may be referred to as a ‘clique’ in the relevant professional networking literature. The likelihood that these locations are related increases proportionally with the number of fully-connected locations. While a fully connected subgraph represents a high-accuracy method for merchant aggregation from this data structure, it is suggested with the understanding that such an algorithm would be less efficient than the proposed edge-weighting.

It will be appreciated by those skilled in the art that the method described above may be operated by a machine operator having a suitable interface mechanism, and/or more typically in an automated manner, for example by operation of a network-enabled computer system including a processor executing a system of instructions stored on a machine-readable medium, RAM, hard disk drive, or the like. The instructions will cause the processor to operate in accordance with the present disclosure.

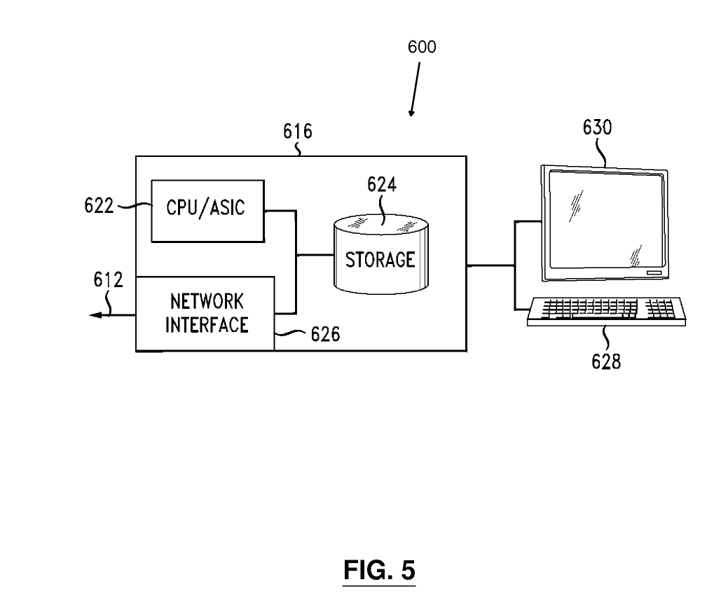

Turning then to FIG. 5, illustrated schematically is a representative computer 616 of the system 600. The computer 616 includes at least a processor or CPU 622 that is operative to act on a program of instructions stored on a computer-readable storage medium 624. Execution of the program of instruction causes the processor 622 to carry out, for example, the methods described above according to the various embodiments. It may further or alternately be the case that the processor 622 comprises application-specific circuitry including the operative capability to execute the prescribed operations integrated therein. The computer 616 will in many cases includes a network interface 626 for communication with an external network 612. Optionally or additionally, a data entry device 628 (e.g., keyboard, mouse, trackball, pointer, etc.) facilitates human interaction with the server, as does an optional display 630. In other embodiments, the display 630 and data entry device 628 are integrated, for example a touch-screen display having a graphical user interface (or GUI).

Variants of the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims.

I/We claim:

1. A method of aggregating merchant data from transaction data, the method comprising:
retrieving a transaction data set from a data warehouse, the transaction data set including a merchant location identifier and the corresponding merchant's Doing Business As (DBA) name and address data;
forming a data set having therein merchant locations exhibiting at least a threshold level of common cardholder patronage;
calculating a metric related to the textual similarity between a merchant location's DBA name for each pair of merchant locations within the data set;
responsive to each pair of merchant locations having a metric related to the textual similarity between the merchant locations' DBA names exceeding a predetermined threshold, aggregating the merchant locations making up the pair with each other where the merchant locations making up the pair do not share an address; and
recording the aggregation between merchant locations in the data warehouse.

2. The method according to claim 1, further comprising pre-processing the merchant DBA name to remove common, generic or descriptive terms.

3. The method according to claim 2, wherein the common, generic or descriptive terms removed from the merchant DBA name are related to the goods or services sold by the merchant, or to the geographic location of the merchant.

4. The method according to claim 1, wherein the transaction data set comprises transactions occurring within at least one of a predetermined time period, a predetermined geographical location, and involving predetermined merchant characteristics.

5. The method according to claim 1, further comprising graphically representing the transaction data set as an interconnected network, wherein the merchant locations correspond to nodes of the network, and the nodes are connected by edges which correspond to at least one cardholder patronizing the merchant location nodes on either side of the edge.

6. The method according to claim 1, wherein the threshold level of common cardholder patronage is related to at least one of a number of cardholders patronizing both merchant locations of a pair, a number of transactions with both merchants each cardholder makes, a percentage of common cardholders as a portion of the client base for each connected merchant location independently, the product of the percentage of cardholders overlapping from each location independently, or some combination of these.

7. The method according to claim 1, wherein the metric related to the textual similarity between the merchant locations' DBA names comprises at least one of inverse document frequency measurement, Levenshtein Distance, a Soundex comparison, and a value related to each common substring of any length between the respective merchant locations' DBA names.

8. The method according to claim 1, further comprising identifying for aggregation merchant locations which are constituents of a fully connected subgraph.

9. A system for aggregating merchant data from transaction data, the system comprising:
a processor;
a non-transitory machine-readable storage medium, storing thereon a program of instruction that, when executed by the processor, causes the processor to carry out a method including
retrieving transaction data set from a data warehouse, the transaction data set including a merchant location identifier and the corresponding merchant's Doing Business As (DBA) name and address data;
forming a data set having therein merchant locations exhibiting at least a threshold level of common cardholder patronage;
calculating a metric related to the textual similarity between a merchant location's DBA name for each pair of merchant locations within the data set;
responsive to each pair of merchant locations having a metric related to the textual similarity between the merchant locations' DBA names exceeding a predetermined threshold, aggregating the merchant locations making up the pair with each other where the merchant locations making up the pair do not share an address; and
recording the aggregation between merchant locations in the data warehouse.

10. The system according to claim 9, wherein the a program of instruction that, when executed by the processor, further causes the processor to
pre-process the merchant DBA name to remove common, generic or descriptive terms.

11. The system according to claim 10, wherein the common, generic or descriptive terms removed from the merchant DBA name are related to the goods or services sold by the merchant, or to the geographic location of the merchant.

12. The system according to claim 9, wherein the transaction data set comprises transactions occurring within at least one of a predetermined time period, a predetermined geographical location, and involving predetermined merchant characteristics.

13. The system according to claim 9, wherein the a program of instruction that, when executed by the processor, further causes the processor to
graphically represent the transaction data set as an interconnected network, wherein the merchant locations correspond to nodes of the network, and the nodes are connected by edges which correspond to at least one cardholder patronizing the merchant location nodes on either side of the edge.

14. The system according to claim 9, wherein the threshold level of common cardholder patronage is related to at least one of a number of cardholders patronizing both merchant locations of a pair, a number of transactions with both merchants each cardholder makes, a percentage of common cardholders as a portion of the client base for each connected merchant location independently, the product of the percentage of cardholders overlapping from each location independently, or some combination of these.

15. The system according to claim 9, wherein the metric related to the textual similarity between the merchant locations' DBA names comprises at least one of inverse document frequency measurement, Levenshtein Distance, a Soundex comparison, and an value related to each common substring of any length between the respective merchant locations' DBA names.

16. The system according to claim 9, wherein the a program of instruction that, when executed by the processor, further causes the processor to
identify for aggregation merchant locations which are constituents of a fully connected subgraph.

17. A non-transitory machine-readable storage medium, storing thereon a program of instruction that, when executed by a processor, causes the processor to carry out a method including
retrieving transaction data set from a data warehouse, the transaction data set including a merchant location identifier and the corresponding merchant's Doing Business As (DBA) name and address data;
forming a data set having therein merchant locations exhibiting at least a threshold level of common cardholder patronage;
calculating a metric related to the textual similarity between a merchant location's DBA name for each pair of merchant locations within the data set;
responsive to each pair of merchant locations having a metric related to the textual similarity between the merchant locations' DBA names exceeding a predetermined threshold, aggregating the merchant locations making up the pair with each other where the merchant locations making up the pair do not share an address; and
recording the aggregation between merchant locations in the data warehouse.

18. The non-transitory machine-readable storage medium according to claim 17, wherein the a program of instruction that, when executed by the processor, further causes the processor to
pre-process the merchant DBA name to remove common, generic or descriptive terms.

19. The non-transitory machine-readable storage medium according to claim 18, wherein the common, generic or descriptive terms removed from the merchant DBA name are related to the goods or services sold by the merchant, or to the geographic location of the merchant.

20. The non-transitory machine-readable storage medium according to claim 17, wherein the transaction data set comprises transactions occurring within at least one of a predetermined time period, a predetermined geographical location, and involving predetermined merchant characteristics.

21. The non-transitory machine-readable storage medium according to claim 17, wherein the a program of instruction that, when executed by the processor, further causes the processor to
graphically represent the transaction data set as an interconnected network, wherein the merchant locations correspond to nodes of the network, and the nodes are connected by edges which correspond to at least one cardholder patronizing the merchant location nodes on either side of the edge.

22. The non-transitory machine-readable storage medium according to claim 17, wherein the threshold level of common cardholder patronage is related to at least one of a number of cardholders patronizing both merchant locations of a pair, a number of transactions with both merchants each cardholder makes, a percentage of common cardholders as a portion of the client base for each connected merchant location independently, the product of the percentage of cardholders overlapping from each location independently, or some combination of these.

23. The non-transitory machine-readable storage medium according to claim 17, wherein the metric related to the textual similarity between the merchant locations' DBA names comprises at least one of inverse document frequency measurement, Levenshtein Distance, a Soundex comparison, and an value related to each common substring of any length between the respective merchant locations' DBA names.

24. The non-transitory machine-readable storage medium according to claim 17, wherein the a program of instruction that, when executed by the processor, further causes the processor to
identify for aggregation merchant locations which are constituents of a fully connected subgraph.
